(19) United States
(12) Patent Application Publication
(10) Pub. No.: US 2007/0078723 A1
(43) Pub. Date: Apr. 5, 2007

(54) System, method and apparatus for conducting secure online monetary transactions

(76) Inventors: James J. Downes, Rochester Hills, MI (US); Mark Johnson, New York, NY (US); Filip Szalewicz, Macomb, MI (US)

Correspondence Address: CHADBOURNE & PARKE, L.L.P., 30 Rockefeller Plaza, New York, NY, 10112, US

(21) Appl. No.: 11/239,930

(22) Filed: Sep. 30, 2005

(51) Int. Cl. G06Q 30/00

(52) U.S. Cl. 705/26

(57) ABSTRACT

A system, apparatus, and methods for conducting secure online monetary transactions are disclosed. In one embodiment, a networked purchasing system includes a media broker, a physical medium producer for manufacturing branded media, one or more merchants, one or more distributors, a consumer networked computer, a financial institution. A media broker further includes a transaction server and a consumer account database. Branded media is, for example, a prepaid compact disk (CD) gift card activated at the point of sale for conducting online monetary transactions. The branded media provides a secure and anonymous alternative to credit cards for conducting online monetary transactions.

### FIELD OF THE INVENTION

The present invention relates, generally, to monetary transactions that are conducted over a communications network. In particular, this invention relates to a system for, an apparatus for, and methods of conducting secure online monetary transactions.

### BACKGROUND OF THE INVENTION

The Internet provides a forum by which consumers and merchants can engage in electronic shopping from globally diverse locations with absolute availability. The Internet continues to capture a growing share of retail business, as evidenced by the tremendous increase in online business-to-consumer transactions over the past several years.

Along with this growth, however, comes a demand by consumers for secure online payment methods. Most online businesses accept only credit cards for payment, so the sensitive financial and personal data contained on a credit card is broadcast over the Internet, i.e., through multiple computer systems that provide the means to read or capture the data. For this reason, prospective online purchasers remain reluctant to provide credit card information via the Internet, which risks interception of the data for exploitative and criminal purposes by hackers. What is needed is a way to conduct online monetary transactions in a manner that maintains anonymity and is, therefore, inherently more secure.

Additionally, there are segments of the population that are not credit card holders and thus, are not able to participant in an online shopping experience for the purchase of, for example, digital content, such as data, music, or video files. Such items may advantageously be transmitted directly from the merchant to a consumer's computer, or physical merchandise, such as clothing or music compact disks (CDs), which are shipped physically from the merchant to the consumer's home. Such segments of the population include children and economically disadvantaged persons. In the case of children, a parent is often reluctant to allow children access to his or her credit card information and, thus, the parent's presence is needed to assist the child in an online purchase. In the case of economically disadvantaged persons, this segment of the population may be excluded completely from participating in an online shopping experience. What is needed is a way to conduct online monetary transactions, without necessarily requiring the use of a credit card.

More specifically, an object of the invention is to provide a secure, simple, and cost-effective method for conducting online monetary transactions, without necessarily requiring the use of a credit card. An advantageous means to this end must provide a highly secure, robust, universal, and cost-effective solution for conducting high-speed transactions over the Internet, from virtually any location.

It is therefore an object of the invention to provide a system for, an apparatus for, and methods of conducting online monetary transactions in a manner that maintains anonymity and is, therefore, inherently more secure.

It is another object of this invention to provide a system for, an apparatus for, and methods of conducting online monetary transactions, without necessarily requiring the use of a credit card.

It is yet another object of this invention to provide a system for, an apparatus for, and methods of conducting online monetary transactions in a secure, simple, and cost-effective manner and without necessarily requiring the use of a credit card.

It is yet another object of this invention to provide a system for, an apparatus for, and methods for conducting high-speed monetary transactions over the Internet, from virtually any location and without necessarily requiring the use of a credit card.

### BRIEF SUMMARY OF THE PRESENT INVENTION

The present invention is a networked purchasing system that facilitates the use of branded media in the form of, for example, a prepaid CD gift card apparatus for conducting online monetary transactions. In doing so, the networked purchasing system and apparatus of the present invention allow online monetary transactions to occur in a manner that maintains anonymity, i.e., no credit card information is required, and the procedure is, therefore, inherently more secure.

It is to be understood that although the term monetary transaction is used throughout the specification, the transactions are not necessarily tied to a particular dollar amount. More specifically, the transactions may be for a particular unit value associated with an item. For example, a gift card may be generated that is redeemable for a particular number (units) of downloadable songs or other digital media.

The branded media, such as the prepaid CD gift card apparatus, is activated at the point of sale and is utilized as a payment option for conducting online monetary transactions for the purchase of branded merchandise. The branded media provides a secure and anonymous alternative to the use of credit cards for conducting online monetary transactions.

The networked purchasing system for, apparatus for, and associated methods of the present invention facilitate online monetary transactions in a secure, simple, and cost-effective manner and, furthermore, facilitate high-speed monetary transactions over the Internet, from virtually any location.

### BRIEF DESCRIPTION OF THE DRAWINGS

FIG. 1 illustrates a functional block diagram of a networked purchasing system in accordance with the invention.

FIG. 2 illustrates a flow diagram of an example method of using the networked purchasing system and branded media of the present invention.

FIG. 3 illustrates a flow diagram of an example business process that is associated with the networked purchasing system and branded media of the present invention.

### DETAILED DESCRIPTION OF THIS INVENTION

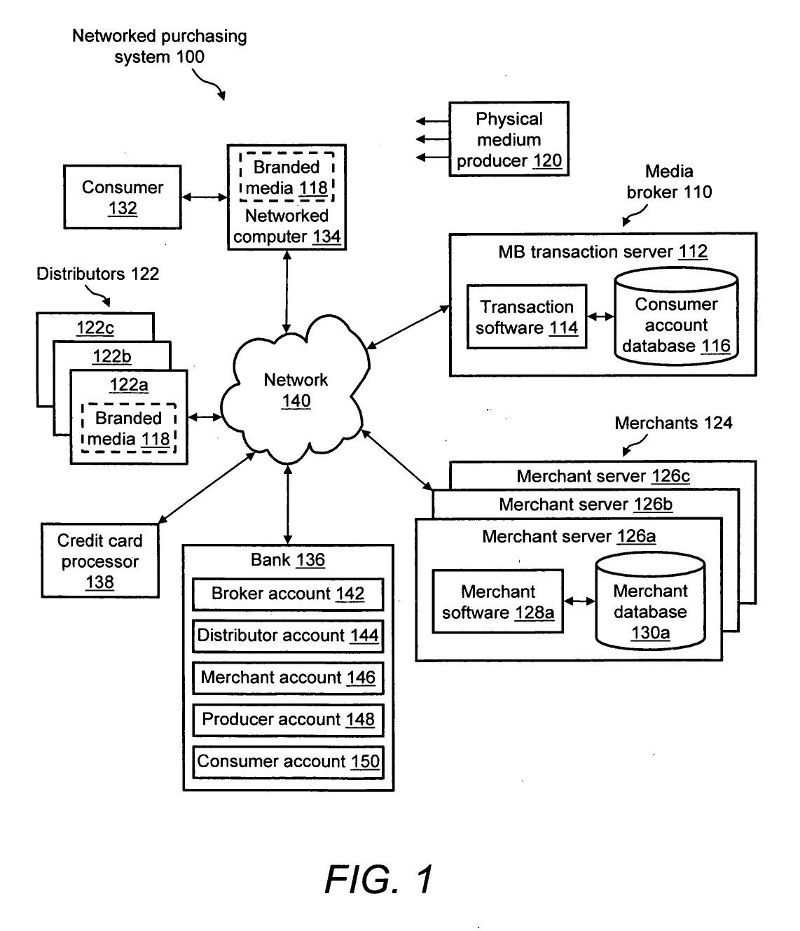

FIG. 1 illustrates a functional block diagram of a networked purchasing system 100 in accordance with the invention. Networked purchasing system 100 includes a media broker 110 that further includes a media broker (MB) transaction server 112, upon which is loaded transaction software 114 for managing a consumer account database 116. Media broker 110 manages the distribution of branded media 118 that is manufactured by a physical medium producer 120. Branded media 118 is distributed to a plurality of distributors 122, e.g., distributors 122a, 122b, and 122c.

Networked purchasing system 100 further includes a plurality of merchants 124 that each includes a merchant server 126 upon which is loaded merchant software 128 for managing a merchant database 130. For example, a merchant 124a, 124b, and 124c (not explicitly shown) includes merchant servers 126a, 126b, and 126c, respectively, that further include merchant software 128a, 128b, and 128c, respectively, and merchant databases 130a, 130b, and 130c, respectively.

Networked purchasing system 100 further includes a consumer 132 who has an associated networked computer 134, a bank 136, and a credit card processor 138. Additionally, MB transaction server 112 of media broker 110, distributors 122, merchant servers 126 of merchants 124, networked computer 134, bank 136, and credit card processor 138 are all connected via a network 140, which represents a wide area network (WAN) for connecting to the Internet.

Media broker 110 is an entity that enters into a business relationship with one or more merchants 124 for providing a mechanism, i.e., branded media 112, by which each consumer 132 may perform a secure online monetary transaction for purchasing goods or services, such as branded merchandise from one or more merchants 124. Furthermore, the mechanism provided by media broker 110 for conducting a secure online monetary transaction does not necessarily include the use of a credit card and is, therefore, suitable for use by segments of the population that are not credit card holders, such as children.

Media broker 110 is represented by MB transaction server 112, which hosts transaction software 114 and consumer account database 116. Transaction software 114 is a software module for managing consumer account database 116 and the online monetary transactions that take place between consumer 132, and merchants, illustrated as merchant servers 126. Consumer account database 116 is implemented as a database, such as an Oracle database, by Oracle Corporation (Redwood Shores, Calif.) customized to facilitate the data flow between system modules associated with the invention.

Consumer account database 116 is a comprehensive collection of related data and, more particularly, according to an embodiment of the invention a collection of data related to managing branded media 118 distribution and coordinating monetary transactions. Which is a mechanism in accordance with the invention for conducting online monetary transactions between consumers and merchants.

In an implementation of the invention, a unique identification number (UIN) and a monetary or unit value associated with each instance of branded media 118 is stored within consumer account database 116 is, as well as links to bank 136 and credit card processor 138. It is to be understood that the purchase or unit value may include but is not limited to a monetary amount or a specific unit amount. For example, a branded media token may be assigned a unit value, so that a consumer may redeem the token to download a certain number of audio/video files.

In addition to associating a purchase value with the branded media, MB transaction server 112 may associate other content, such as special promotions, email addresses for sending special promotions, and other content of interest to consumer 132 with the branded media. In one implementation, Media broker 110 serves as a broker for distributing branded content between an online store (represented by each merchant 124) and a population of consumers, such as consumer 132. In other implementations, Media broker 110 may coordinate the distribution of branded media through brick and mortar stores, instead of or in addition to online stores. Accordingly, Media broker 110 enables a mechanism (i.e., branded media 118) for conducting online monetary transactions between merchant 124 and consumer 132, without requiring the use of a credit card and, thereby, ensuring anonymity, because no credit card information is exchanged.

Branded media 118 is any physical media capable of storing digital content and that is accessible to a consumer, such as a computer's optical CD disk drive, floppy disk drive, or USB port. Stored upon branded media 118 is, for example, branded digital content, such as an audio or video file, and/or links (e.g., URLs) to the web sites of merchant servers 126 for directing the user to online content, such as shopping catalogs.

In one example, merchant 124a distributes branded merchandise related to NASCAR auto racing and, thus, branded media 118, associated with merchant 124a, contains branded content related to NASCAR auto racing, such as a video related to a certain NASCAR driver or race as well as links to a NASCAR online shopping catalog for purchasing NASCAR memorabilia. In this example, branded media 118 not only provides a link to the NASCAR shopping web site, but also provides content of interest (i.e., a “collectable”) to the user, in the form of the NASCAR video or audio. It is to be understood that branded media 118 may be associated with one specific merchant 124, such as merchant 126a or with a plurality of merchants 124, such as merchants 126a, 126b, and 126c depending on the implementation. Transaction software 114 of MB transaction server 112 manages the transfer of funds properly.

Branded media 118 is, for example but is not limited to, a gift card, in the form of a recordable CD, i.e., CD-ROM, which may be purchased and activated at any distributor 122. The CD gift card may be a mini CD that is 8 cm in diameter or a CD that is 12 cm in diameter. In another example, branded media 118 is a small, easily transportable recordable CD-ROM, as described in pending, commonly assigned reference, U.S. patent application Ser. No. 11/199,598, entitled, “Methods and apparatus for conducting secure, online monetary transactions.” In yet further examples, branded media 118 is implemented as a writeable/readable CD, a digital video disk (DVD), a flash drive device, a memory card, a smart card, a magnetic strip, a radio frequency identification (RFID) tag, E Ink paper (electronic paper), or electronic devices, such a personal digital assistant (PDA), a mobile phone, or a digital music player, e.g., an iPod, or any combination of the above.

Physical medium producer 120 is any manufacturer of digital storage media, such as CDs, and is capable of producing instances of branded media 118 in high volume. The branded content to be loaded on each instance of branded media 118 is determined by a given merchant 124 and media broker 110. In one implementation, the packaging of each instance of branded media 118 includes a UIN printed thereon. In alternate implementations, the UIN may be embedded in the packaging for point-of-sale (POS) activation. For example, the packaging includes, a magnetic strip, a bar code, or an RFID tag that correlates to the printed UIN.

Once manufactured, the packaged branded media 118 is shipped in high volume to distributors 122, e.g., distributors 122a, 122b, and 122c. Distributors 122 are, for example but are not limited to, any retail facility, such as a department store, grocery store, or drug store. Alternatively, distributors 122 are online shopping stores or the distributors of other branded products into or onto which branded media 118 may be affixed. For example, an instance of branded media 118 may be packaged inside a box of breakfast cereal, as a giveaway item. Other distribution methods may be employed, such as mailing an instance of branded media 118 to a consumer's home.

In the case in which distributor 122 is a retail facility, distributor 122 includes a standard POS activation system (not shown). At the time of purchase, the POS activation system transmits the LIN data that is associated with the instance of branded media 118 to MB transaction server 112 for activation verification. Branded media 118 is provided a prepaid monetary value, for conducting an online monetary transaction with a given merchant 124.

Each merchant 124 is representative of any provider of branded products, such as branded products related to a professional sports entity (e.g., Major League Baseball (MLB), the National Football League (NFL), the National Basketball Association (NBA), and NASCAR auto racing), clothing, sporting goods, music, or movies. Each merchant server 126 hosts its associated online content, such as shopping web site(s), which is accessible via the Internet by use of network 140. Each instance of merchant software 126 is a software module used for managing its associated merchant database 130 and the online monetary transactions that take place between consumers, e.g., consumer 132, and merchants 124. Merchant database 130 is a database, such as an Oracle database, which is a comprehensive collection of data, such as merchandise catalogs related to the branded merchandise of a given merchant 124 and the sale thereof.

Consumer 132 is any individual, group, or entity that is in possession of an instance of branded media 118, for the purpose of conducting a secure online monetary transaction with one or more merchants 124, by use of networked computer 134. Networked computer 134 is a computer, such as a personal computer or laptop computer, that has connectivity to the Internet via network 140. The use of branded media 118 (a prepaid item that represents a monetary or unit value) does not necessarily require the use of a credit card and, thus, inherently allows consumer 132 to conduct an anonymous online monetary transaction and, thereby, provides increased security against the theft of credit card information.

Bank 136 is any financial institution for handling bank accounts and the transfer of funds to and from other banking or financial institutions. In the example of networked purchasing system 100, bank 136 manages the bank accounts of, for example, media broker 110, distributors 122, and/or merchants 124. For example, bank 136 manages a broker account 142, which is a bank account that is associated with media broker 110; a distributor account 144, which is a bank account that is associated with a distributor 122; a merchant account 146, which is a bank account that is associated with a merchant 124; a producer account 148, which is a bank account that is associated with physical medium producer 120; and a consumer account 150, which is a bank account that is associated with consumer 132. It is to be understood that the various accounts associated with the entities interaction with the system are not necessarily held by the same bank and may be distributed among any number of financial institutions.

Credit card processor 138 is any credit card institution that manages the credit card authentication and approval process for, in this example, an online monetary transaction.

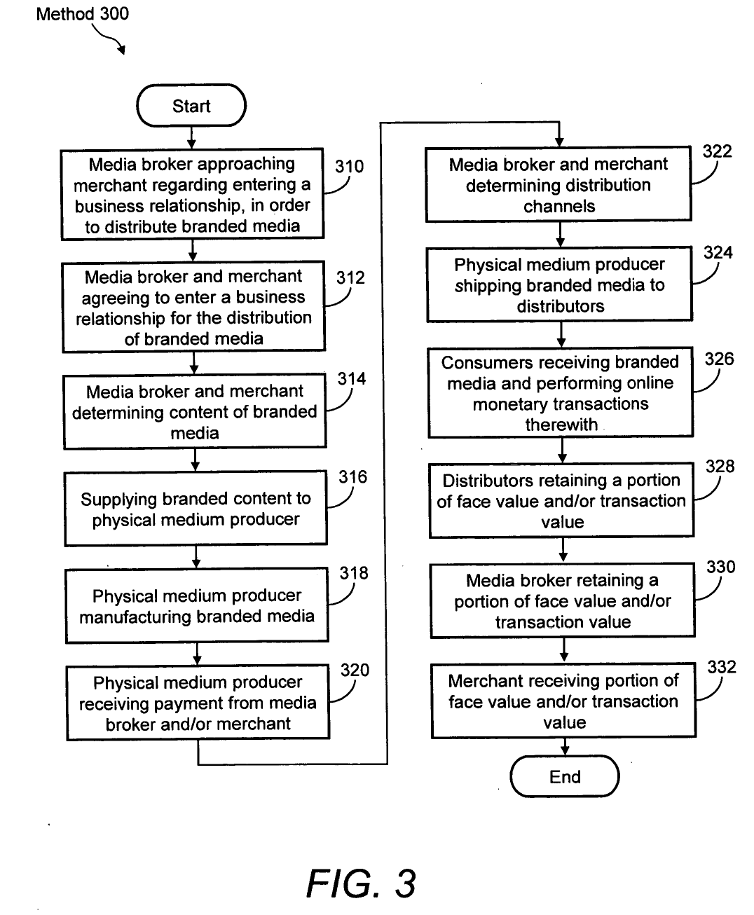

In an example wherein branded media 118 is a prepaid CD gift card that is packaged with a UIN, wherein distributors 122 are retail facilities, and wherein it is assumed that media broker 110 has a pre-established business relationship with distributors 122 and merchants 124, (described in more detail in reference to FIG. 3), the operation of networked purchasing system 100 is as follows:

By use of physical medium producer 120, media broker 110 produces branded media 118, for example, a branded optical media product in the form of a prepaid CD gift card. Branded media 118 is distributed to consumers, e.g., consumer 132, through distributors 122. The packaging of branded media 118 includes a UIN printed thereon and has a magnetic strip, bar code, or RFID tag that correlates to the printed UIN. Consumer 132 selects an instance of branded media 118 and proceeds to a retail checkout register (not shown) at, for example, distributor 122a.

Consumer 132 pays for the branded media 118, which has a predetermined or consumer-determined value, such as $25. The clerk (not shown) at the retail checkout register reads the UIN from the package of branded media 118 by, for example, swiping the magnetic strip, reading the bar code with a bar code reader, scanning the RFID tag with an RFID reader, or entering the UIN manually via the register keypad. The UIN data, along with related sales data, such as the monetary or unit value of the particular instance of branded media 118, is transmitted by the POS activation system of distributor 122a to MB transaction server 112 via network 140, for activation verification.

Transaction software 114 of MB transaction server 112 then transmits an activation confirmation back to distributor 122a via network 140. Transaction software 114 of MB transaction server 112 also logs an entry of the UIN and the value of the particular instance of branded media 118 within consumer account database 116. Upon the purchase of branded media 118 at distributor 122a, monetary funds (e.g., a percentage of the face value of branded media 118) are transferred from distributor account 144 to broker account 142 at bank 136.

Consumer 132 places branded media 118 into, for example, the CD-ROM drive of his/her networked computer 134. In doing so, content of interest, such as a video or audio collectable related to branded media 118 is presented by networked computer 134 to consumer 132. Additionally, a link is established via network 140 between networked computer 134 and MB transaction server 112. Transaction software 114 of MB transaction server 112 presents an initial login screen to consumer 132 that prompts consumer 132 to enter the UIN that is printed on the packaging of branded media 118. Transaction software 114 of MB transaction server 112 generates a server-based, user-specific account upon consumer account database 116 that is funded to the purchase value of the particular instance of branded media 118. The stored value of branded media 118 may be represented as monetary (e.g., $25) or as a unit value, such as a prescribed combination of digital assets (e.g., 3 songs, 2 ring tones, 1 video). Redemption of value may be for digital assets, which are downloaded to networked computer 134, or for physical merchandise, which is shipped to consumer 132.

Once the instance of branded media 118 is authenticated by transaction software 114 of MB transaction server 112, a shopping menu and the balance of the prepaid value of branded media 118 is presented to consumer 132. In doing so, a link is established via network 140 between networked computer 134 and a given merchant server 126, such as merchant server 126a, that is associated with the particular instance of branded media 118. The shopping menu is, for example, a multi-media user interface that is based on a combination of content that is located on branded media 118 and/or merchant server 126a. The user is provided the ability to browse, for example, a media library that includes various digital content, such as music, videos, and ring tones, or a catalog of physical merchandise, such as hats and T-shirts. Consumer 132 identifies which content he/she wishes to acquire and places these items in his/her “shopping cart” that is displayed on networked computer 134 by merchant software 128a of merchant server 126a. Subsequently, merchant software 128a of merchant server 126a displays a “checkout” page to consumer 132. Consumer 132 selects the payment option of branded media 118 and initiates the checkout operation.

Transaction software 114 of MB transaction server 112 queries consumer account database 116, in order to confirm that the consumer account that is associated with the UIN of the particular instance of branded media 118 has sufficient “funding” for the requested merchandise. Once funding is confirmed, the delivery of merchandise by merchant 124a to consumer 132 is initiated.

In the case of digital content, the digital content that resides on merchant database 130a of merchant server 126a is transferred to networked computer 134 of consumer 132 via network 140. In the case of physical merchandise, the requested merchandise is shipped to a physical address that is entered at the checkout page by consumer 132. Upon successful completion of the online monetary transaction, the consumer account that is associated with the given UIN of branded media 118 is decremented by the proper amount, and monetary funds are transferred from broker account 142 to merchant account 146 at bank 136.

In the event that a request for merchandise exceeds present account funding, transaction software 114 of MB transaction server 112 presents reload alternatives to consumer 132. The ability to reload monetary value to branded media 118 may be implemented by any number of electronic payment techniques including, but not limited to, credit card, debit card, automated clearing house (ACH) network, direct deposit, or charging to a telephone bill. In the example of reloading monetary value to branded media 118 via a credit card or a debit card, credit card processor 138 is used to handle the credit card authentication and approval process. Throughout all online monetary transactions of networked purchasing system 100 of the present invention, transaction software 114 of MB transaction server 112 tracks all details regarding requests, delivery, and funding and updates consumer account database 116 accordingly.

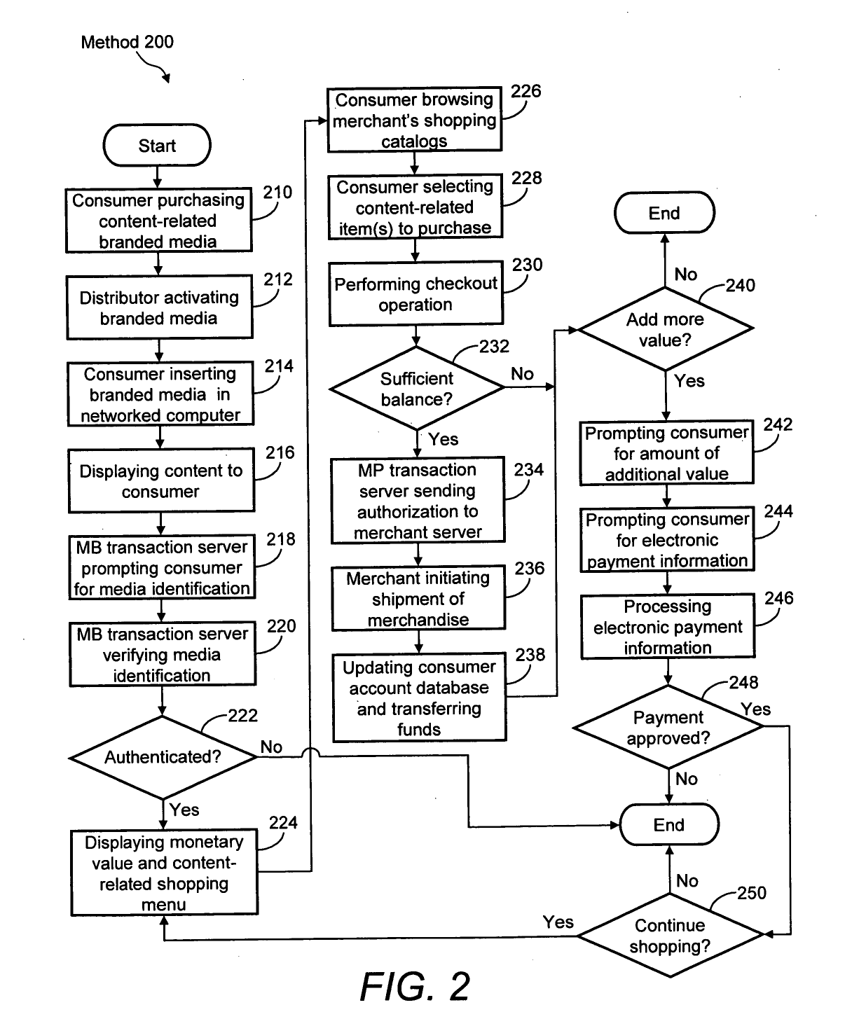

FIG. 2 illustrates a flow diagram of an example method 200 of using networked purchasing system 100 and branded media 118 of the present invention. Method 200 illustrates an example use of networked purchasing system 100 with the following assumptions: (1) branded media 118 is a prepaid CD gift card that is packaged with a UIN, (2) distributors 122 are retail facilities, and (3) media broker 110 has a pre-established business relationship with distributors 122 and merchants 124. The use of networked purchasing system 100 and branded media 118 of the present invention is not limited to that illustrated in method 200; method 200 is exemplary only. Method 200 includes the steps of:

In step 210, consumer 132 selects an instance of branded media 118 at, for example, distributor 122a (a retail facility) and proceeds to a retail checkout register. Consumer 132 pays for the branded media 118, which has a predetermined or consumer-determined purchase value, such as $25. Method 200 proceeds to step 212.

At step 212, branded media 118 is activated at distributor 122a. More specifically, the clerk (not shown) at the retail checkout register reads the UIN from the package of branded media 118 by, for example, swiping the magnetic strip, reading the bar code with a bar code reader, scanning the RFID tag with an RFID reader, or entering the UIN manually via the register keypad. The UIN data, along with related sales data, such as the monetary or unit value of the particular instance of branded media 118, is transmitted by the POS activation system of distributor 122a to MB transaction server 112 via network 140, as an activation request. Transaction software 114 of MB transaction server 112 then transmits an activation confirmation back to distributor 122a via network 140. Transaction software 114 of MB transaction server 112 also logs an entry of the UIN and the value of the particular instance of branded media 118 within consumer account database 116. Method 200 proceeds to step 214.

At step 214, consumer 132 places branded media 118 into, for example, the CD-ROM drive of his/her networked computer 134. In an embodiment of the invention, this step involves the foundation for the consumer submitting a registration request, in order to use the branded media 118. Method 200 proceeds to step 216.

At step 216, content of interest, i.e., a collectable, that is related to branded media 118 is presented by networked computer 134 to consumer 132 as, for example, a video and/or audio presentation. Method 200 proceeds to step 218.

At step 218, MB transaction server 112 prompts consumer 132 for the identification of branded media 118. More specifically, a link is established via network 140 between networked computer 134 and MB transaction server 112. Transaction software 114 of MB transaction server 112 presents an initial login screen to consumer 132 that prompts consumer 132 to enter the UIN that is printed on the packaging of branded media 118. Method 200 proceeds to step 220.

At step 220, MB transaction server 112 performs a verification process. More specifically, the UIN data is transmitted from networked computer 134 to transaction software 114 of MB transaction server 112 and then transaction software 114 compares the UIN of the branded media 118 that is entered in step 218 by consumer 132 to UINs that are logged within consumer account database 116 and that have an “activated” status, meaning that a POS activation process has occurred for that UIN. Method 200 proceeds to step 222.

At decision step 222, if the authentication operation of step 220 is successful, transaction software 114 of MB transaction server 112 generates a server-based, user-specific account upon consumer account database 116 that is funded to the purchase value of the particular instance of branded media 118, and method 200 proceeds to step 224. If the authentication operation of step 220 is not successful, method 200 ends.

At step 224, the balance of the prepaid value of branded media 118, which is transmitted from MB transaction server 112 to networked computer 134, and a content-related shopping menu are presented to consumer 132 by, for example, displaying on the monitor of networked computer 134. In doing so, a link is established via network 140 between networked computer 134 and a given merchant server 126 that is associated with the particular instance of branded media 118, such as merchant server 126a. The shopping menu is, for example, a multi-media user interface that is based on a combination of content that is located on branded media 118 and merchant server 126a. Method 200 proceeds to step 226.

At step 226, consumer 132 is directed to one or more online shopping catalogs via one or more URLs and is provided the ability to browse, for example, an online media library that includes various digital content, such as music, videos, and ring tones, or an online catalog of branded physical merchandise, such as hats and T-shirts. The online media library and merchandise catalog is hosted by merchant server 126a. Method 200 proceeds to step 228.

At step 228, consumer 132 identifies which content he/she wishes to acquire and places these items in his/her “shopping cart” that is displayed on networked computer 134 by merchant software 128a of merchant server 126a. Method 200 proceeds to step 230.

At step 230, a checkout operation is performed. More specifically, merchant software 128a of merchant server 126a displays a “checkout” page to consumer 132. The checkout page may include a selection of several electronic payment options, such as various credit card types as well as a payment option via branded media 118. Consumer 132 selects the payment option of branded media 118 and initiates the checkout operation. Method 200 proceeds to step 232.

At decision step 232, transaction software 114 of MB transaction server 112 queries consumer account database 116, in order to determine whether the consumer account that is associated with the UIN of the particular instance of branded media 118 has sufficient “funding” for the requested merchandise. If yes, method 200 proceeds to step 234. If no, method 200 proceeds to step 240.

At step 226, transaction software 114 of MB transaction server 112 transmits an authorization to merchant software 128a of merchant server 126a. The authorization indicates to merchant server 126a that there is a sufficient balance in the consumer account and, thus, the transaction may proceed. Method 200 proceeds to step 236.

At step 236, the delivery of merchandise by merchant 124a to consumer 132 is initiated. In the case of digital content, the digital content that resides on merchant database 130a of merchant server 126a is transferred to networked computer 134 of consumer 132 via network 140. In the case of physical merchandise, the requested merchandise is shipped to a physical address that is entered at the checkout page by consumer 132. Method 200 proceeds to step 238.

At step 238, the consumer account within consumer account database 116 that is associated with the given UIN of branded media 118 is decremented by the proper amount and monetary funds are transferred from broker account 142 to merchant account 146 at bank 136. Method 200 proceeds to step 240.

At decision step 240, consumer 132 decides whether he/she wishes to add additional monetary value to his/her instance of branded media 118. If yes, consumer 132 selects a “reload” option and method 200 proceeds to step 242. If no, method 200 ends.

At step 242, transaction software 114 of MB transaction server 112 prompts consumer 132 to enter a monetary value in an entry field that is displayed on networked computer 134. Method 200 proceeds to step 244.

At step 244, transaction software 114 of MB transaction server 112 presents one or more reload alternatives to consumer 132. The ability to reload monetary value to branded media 118 by use of any number of electronic payment techniques including, but not limited to, credit card, debit card, ACH network, direct deposit, or charging to a telephone bill. Method 200 proceeds to step 246.

At step 246, the electronic payment information is processed. More specifically, in the case of reloading monetary value to branded media 118 via a credit card or debit card, transaction software 114 of MB transaction server 112 passes the credit card information to credit card processor 138, which is used to handle the credit card authentication and approval process. Alternatively, any number of other electronic payment methods may be implemented, such as transferring funds directly from consumer account 150 to broker account 142 at bank 136. Method 200 proceeds to step 248.

At decision step 248, it is determined whether the electronic payment is approved. More specifically, credit card processor 138 processes the credit card information received in step 246. If the credit card is approved, credit card processor 138 passes an approval code to transaction software 114 of MB transaction server 112 and method 200 proceeds to step 250. If the credit card is not approved, method 200 ends.

At decision step 250, consumer 132 decides whether he/she wishes to continue shopping online. If yes, method 200 returns to step 224. If no, method 200 ends.

Throughout all the operations of steps 210 through 250 of method 200, transaction software 114 of MB transaction server 112 tracks all details regarding requests, delivery, and funding and updates consumer account database 116 accordingly.

Networked purchasing system 100, as described in reference to FIGS. 1 and 2, uses branded media 118 to provide a secure and anonymous alternative to the use of credit cards for conducting online monetary transactions.

FIG. 3 illustrates a flow diagram of an example business process (i.e., a method 300) that is associated with networked purchasing system 100 and branded media 118 of the present invention. Method 300 is an example business process that allows media broker 110 to establish a business relationship with one or more merchants 124, in order to create branded media 118 that is sold through one or more distributors 122.

At step 310, media broker 110 approaches a given merchant 124 regarding entering a business relationship, in order to distribute branded media 118 that is associated with the given merchant 124. For example, if the given merchant 124 is NASCAR auto racing, media broker 110 approaches merchant 124 regarding entering a business relationship, in order to distribute branded media 118 that is related to NAS CAR products. Method 300 proceeds to step 312.

At step 312, media broker 110 and the given merchant 124 agrees to enter a business relationship for the distribution of branded media 118 and agrees on terms of a contract to do so. Method 300 proceeds to step 314.

At step 314, media broker 110 and the given merchant 124 determines the exact branded content to be included upon branded media 118. By way of example only, the branded content may be a video file of an interview with a NASCAR driver. Method 300 proceeds to step 316.

At step 316, the branded content that is determined in step 314 is supplied to physical medium producer 120. Method 300 proceeds to step 318.

At step 318, physical medium producer 120 manufactures instances of branded media 118 in high volume. The branded content to be loaded on each instance of branded media 118 is determined by a given merchant 124 and media broker 110. The packaging of each instance of branded media 118 includes associating a UIN with the media. Furthermore, for the purpose of POS activation, the packaging includes, for example, a magnetic strip, bar code, or RFID tag that correlates to a printed UIN. Method 300 proceeds to step 320.

At step 320, physical medium producer 120 receives payment from media broker 110 for the volume of branded media 118 that is manufactured in step 318, for example, by media broker 110 authorizing the direct transfer of funds from broker account 142 to producer account 148 at bank 136. Method 300 proceeds to step 322.

At step 322, media broker 110 and the given merchant 124 determine the distribution channels for distributing branded media 118. For example, both media broker 110 and the given merchant 124 may have pre-established distribution channels, such as one or more online distributors, in addition to or instead of one or more physical retail facilities. The agreed upon distribution channels may be the distribution channels of media broker 110, the given merchant 124, or some combination/subset of both. Method 300 proceeds to step 324.

At step 324, a quantity of packaged branded media 118 is shipped by physical medium producer 120 to distributors 122, e.g., distributors 122a, 122b, and 122c. Distributors 122 include, but are not limited to, retail facilities, online shopping stores, or distributors of other branded products. For example, an instance of branded media 118 may be packaged inside a box of breakfast cereal, as a giveaway item. Method 300 proceeds to step 326.

At step 326, consumers 132 receive branded media 118 and perform online monetary transactions therewith, for example, according to method 200 of FIG. 2, in order to receive branded merchandise. Method 300 proceeds to step 328.

At step 328, distributors 122 retain, for example, a portion of the face value of each branded media 118 that is sold or a portion of the amount of the monetary transaction that occurs between consumer 132 and merchant 124 by use of branded media 118 and networked purchasing system 100 of the present invention. For example, a percentage of the face value of instances of branded media 118 sold at distributors 122 is transferred from distributor account 144 to broker account 142. This percentage is, for example, 80-85% of the branded media 118 face values. According to this example, 15-20% of the face value of instances of branded media 118 is retained by distributors 122, as an incentive to sell branded media 118 on behalf of media broker 110 and merchants 124. Method 300 proceeds to step 330.

At step 330, upon successful completion of an online monetary transaction by use of networked purchasing system 100, the consumer account that is associated with a given UIN of branded media 118 is decremented by the proper amount and monetary funds that are transferred from broker account 142 to merchant account 146 at bank 136. However, in doing so, media broker 110 retains, for example, a portion of the face value of each branded media 118 that is sold or a portion of the amount of the monetary transaction that occurs between consumer 132 and merchant 124 by use of branded media 118 and networked purchasing system 100 of the present invention. Method 300 proceeds to step 332.

At step 332, funds are transferred from broker account 142 to merchant account 146 at bank 136 in an amount equal to, for example, a portion of the face value of each branded media 118 that is sold or a portion of the amount of the transaction that occurs between consumer 132 and merchant 124 by use of branded media 118 and networked purchasing system 100 of the present invention. Method 300 ends.

The present invention is not limited to the specific embodiment of networked purchasing system 100 and the elements thereof, as described in reference to FIGS. 1, 2, and 3. More specifically, other configurations of networked purchasing system 100, other embodiments of branded media 118, and other process steps for performing an online monetary transaction by use of networked purchasing system 100 are possible. Included within the scope of this invention are alternative embodiments of networked purchasing system 100 and the elements thereof, examples of which are described in more detail below.

In summary and with continuing reference to FIGS. 1, 2, and 3, networked purchasing system 100 of the present invention facilitates the use of branded media 118 in the form of, for example, a prepaid CD gift card apparatus for conducting online monetary transactions. In doing so, networked purchasing system 100 and branded media 118 of the present invention provide a secure and anonymous alternative to the use of credit cards for conducting online monetary transactions, i.e., no credit card information is exchanged, and the procedure is, therefore, inherently more secure.

Branded media 118, such as the prepaid CD gift card apparatus, is activated at the point of sale and is utilized as a payment option for conducting online monetary transactions for the purchase of branded merchandise from merchants 124. Networked purchasing system 100, branded media 118, and associated methods 200 and 300 of the present invention facilitate online monetary transactions in a secure, simple, and cost-effective manner and, furthermore, facilitate high-speed monetary transactions over the Internet, from virtually any location.

Alternative Branded Media Embodiments and Content

The branded media content of interest to consumer 132 (i.e., the “collectable”) that is provided upon the apparatus of branded media 118 is, for example, a content-related video or audio, as well as, web links to the branded merchandise shopping catalogs that reside on merchant servers 126, as described in reference to FIG. 1. Alternatively, there is no collectable residing directly upon branded media 118. Instead, the branded media content upon branded media 118 includes web links only to the content-related video or audio, which are then downloaded to networked computer 134 for presentation to consumer 132, as well as, web links to the branded merchandise shopping catalogs. In this case, the collectable is totally web-based, as there is no video or audio content residing on the physical instantiation of branded media 118.

Alternatively, an instantiation of branded media 118 includes no physical apparatus at all, such as the CD gift card. Instead, branded media 118 is provided to consumer 132 as a URL that is typed into the web browser of networked computer 134. The URL is a web link that directs consumer 132 to an authentication web page for entering the UIN, then to the web site of either media broker 110 or to the web site of a given merchant 124, for providing the functionality, as described in reference to a CD gift card, as described in FIGS. 1 and 2. This functionality allows consumer 132 to download the content of interest (i.e., the “collectable”) and to access the branded merchandise shopping catalogs, in order to conduct an online monetary transaction.

Alternatively, the physical instantiation of branded media 118 is a dual-purpose CD gift card, for example, a CD gift card that can be used to make a purchase at a retail store directly via a bar code or magnetic stripe incorporated thereon or that can be used online, by being inserted into networked computer 134, as described in reference to FIGS. 1 and 2.

Alternatively, the physical instantiation of branded media 118 is provided in the form of other readable devices, such as, but not limited to, an RFID tag, a subscriber identity module (SIM) card, a flash drive device (e.g., USB flash drive), a wireless device (e.g., a Bluetooth® device), a bar code printed on packaging or any combination thereof.

Alternatively, the physical instantiation of branded media 118 is provided as a preexisting electronic device, such as, but not limited to, a mobile phone, an audio or video player (e.g., iPod), a Palm Pilot, or a PDA. In this case, no physical device, such as the CD gift card, is required. Instead, the value of branded media 118 that is purchased, for example, at the POS of a distributor 122, is transferred directly to the preexisting device, which is then used directly to obtain the value of the purchase. Once activated at the POS, a communication link is established between the electronic device and MB transaction server 112. For example, digital content may be transmitted directly to the preexisting device by transaction software 114 of MB transaction server 112.

In an implementation of the mobile phone embodiment of branded media 118, the branded media 118 is activated, for example, through a portal at the POS, by use of the associated telephone number. One of the categories on a system application page associated with the mobile phone embodiment may be, for example, “gifting,” which is selected by consumer 132 for obtaining a certain value of branded media 118 associated with another user's account. Alternatively, a “gifting” software application for a mobile phone may be purchased and downloaded from media broker 110. In the case of branded media 118 in the form of a mobile phone, the branded content is, for example, may include ring tones or wallpaper. Furthermore, the purchase of branded media 118 may be facilitated by applying the cost thereof to the mobile phone bill of consumer 132.

In an implementation of the Palm Pilot embodiment of branded media 118, because the Palm Pilot has more functionality than a mobile phone, the branded downloadable digital content may be include email, telephone, camera, or MP3 player applications.

In an implementation of the audio or video player embodiment of branded media 118, such as an iPod, the branded downloadable digital content may include an audio and/or video file for use on the device. For example, consumer 132 may play a video via his/her video iPod, such as the Sony GigaPocket PCVA-HVP20.

Media Alternatives: Data Types vs. Storage Devices

Generally, the types of physical storage devices for implementing branded media 118 may take many forms. Example types of storage devices that are suitable for forming branded media 118 include, but are not limited to, a read-only CD (CD-R), a read/write CD (CD-RW), a DVD, a flash drive, an RFID tag, an audio or video player, such as an iPod, a PDA, a mobile phone, a SIM card, a smart card, a memory chip, a magnetic strip, a hard disk, a floppy disk, an Internet web site, E Ink paper (electronic paper), and the product packaging itself.

Furthermore, the types of data to be stored on branded media 118 are numerous and may be provided in various ways, in relation to the various storage devices listed above. Example types of data include, but are not limited to, a digital video file, a digital audio file, a digital image file, one or more URLs, a password, a UIN, an executable file (i.e., *.exe file), a graphics file, and indicia (i.e., instructions). Table 1 below, illustrates a matrix of data types vs. storage devices. Table 1 correlates each example data type to one or more example storage devices that are suitable for storing the given example data type. It is to be understood that Table 1 is meant for illustrative purposes and that other data types and other storage devices exist and are within the scope of the invention.

TABLE 1
Data types vs. storage devices

| | | DATA TYPES | | | | | | |
|---|---|---|---|---|---|---|---|---|
| | | *All media | | | | | | |
| | | content | URL | Pass word | UIN | *.exe | Graphics | Indicia |
| STORAGE | CD-R | x | x | x | x | x | x | x |
| DEVICES | CD-RW | x | x | x | x | x | x | x |
| | DVD | x | x | x | x | x | x | x |
| | Flash drive | x | x | x | x | x | x | x |
| | iPod | x | x | x | x | x | x | x |
| | PDA | x | x | x | x | x | x | x |
| | Mobile phone | x | x | x | x | x | x | x |
| | SIM card | x | x | x | x | x | x | x |
| | Smart card | x | x | x | x | x | x | x |
| | Memory chip | x | x | x | x | x | x | x |
| | Hard disk | x | x | x | x | x | x | x |
| | Floppy disk | x | x | x | x | x | x | x |
| | Internet | x | x | x | x | x | x | x |
| | RFID | | x | x | x | | | |
| | Magnetic strip | | x | x | x | | | |
| | E Ink paper | | x | x | x | | | |
| | Packaging | | x | x | x | | | |

*All media content = video files, audio files, image files, etc.

With continuing reference to Table 1, a single instance of branded media 118 may include any combination of multiple data types and multiple storage devices, such as, but not limited to those listed in Table 1, examples of which are as follows.

### EXAMPLE 1—

data type=all media content, storage device=CD-R
data type=URL, storage device=CD-R
data type=UIN, storage device=printed on CD-R packaging

### EXAMPLE 2—

data type=all media content, storage device=CD-RW
data type=URL, storage device=CD-RW
data type=UIN, storage device=RFID attached to CD-RW package

### EXAMPLE 3—

data type=all media content, storage device=DVD
data type=URL, storage device=flash drive attached to DVD package
data type=UIN, storage device=flash drive attached to DVD package

### EXAMPLE 4—

data type=all media content, storage device=floppy disk
data type=URL, storage device=floppy disk
data type=UIN, storage device=printed on floppy disk packaging

### EXAMPLE 5—

data type=all media content, storage device=mobile phone
data type=URL, storage device=SIM card
data type=UIN, storage device=SIM card

### EXAMPLE 6—

data type=all media content/storage device=CD-R
data type=URL, storage device=printed on CD-R packaging
data type=UIN, storage device=magnetic strip attached to CD-R packaging
   Alternative System Configurations and Functionality

In an alternative configuration, MB transaction server 112 is not utilized within networked purchasing system 100 and, instead, the functionality of transaction software 114 and consumer account database 116 of MB transaction server 112 resides on each merchant server 126. All operations that are performed by MB transaction server 112 during an online monetary transaction, as described in FIGS. 1, 2, and 3, are, instead, performed by each merchant server 126.

In another alternative configuration, MB transaction server 112 is not utilized within networked purchasing system 100 and, instead, the functionality of transaction software 114 and consumer account database 116 of MB transaction server 112 is provided as a software application on the storage device that forms branded media 118, such as the CD gift card. All operations that are performed by MB transaction server 112 during an online monetary transaction, as described in FIGS. 1, 2, and 3, are, instead, performed by the software application, which executes on networked computer 134. For example, the links to merchant servers 126, bank 136, and credit card processor 138 reside locally on branded media 118. In this example, although merchant server 126 can verify that branded media 118 has monetary value, the authentication process that uses the UIN may be lost. Consequently, any consumer 132 who has physical possession of an instance of branded media 118 may conduct an online monetary transaction therewith, with no further authentication. Furthermore, in this example, the UIN and the current monetary or unit value of branded media 118, which is updated during use thereof, may be stored directly on the prepaid CD gift card.

In yet another alternative configuration, merchant servers 126 are not utilized within networked purchasing system 100 and, instead, the functionality of merchant software 128 and merchant database 130 of each merchant server 126 resides on MB transaction server 112. All operations that are performed by merchant server 126 during an online monetary transaction, as described in FIGS. 1, 2, and 3, are, instead, performed by MB transaction server 112.

In yet another alternative configuration, merchant servers 126 are not utilized within networked purchasing system 100. Instead, the functionality of merchant software 128 and merchant database 130 of each merchant server 126 is provided as a software application on the storage device that forms branded media 118, such as the CD gift card. All operations that are performed by merchant server 126 during an online monetary transaction, as described in FIGS. 1, 2, and 3, are performed by the software application, which executes on networked computer 134. For example, branded digital content is preloaded upon branded media 118, but in a “locked” state and, therefore, it is inaccessible to consumer 132. Once transaction software 114 of MB transaction server 112 completes the authentication process successfully, as described in steps 218 through 222 of method 200 of FIG. 2, consumer 132 conducts an online monetary transaction by use of merchandise catalogs that are preloaded upon branded media 118. When the checkout operation is complete, the selected branded digital content is placed in an “unlocked” state and presented to consumer 132 for consumption. In this example, the shopping experience may be enhanced, because it is managed locally in real time on networked computer 134, not by a slower, web-based process.

In yet another alternative configuration, neither MB transaction server 112 nor merchant servers 126 are utilized within networked purchasing system 100 and, instead, the functionality of transaction software 114 and consumer account database 116 of MB transaction server 112 and the functionality of merchant software 128 and merchant database 130 of each merchant server 126 is provided as a software application on the storage device that forms branded media 118, such as the CD gift card. All operations that are performed by MB transaction server 112 and merchant server 126 during an online monetary transaction, as described in FIGS. 1, 2, and 3, are, instead, performed by the software application, which executes on networked computer 134. In this example, although the software application running on networked computer 134 can verify that branded media 118 has monetary value, the authentication process that uses the UIN may be lost. Consequently, any consumer 132 who has physical possession of an instance of branded media 118 may conduct an online monetary transaction therewith, with no further authentication. Furthermore, in this example, the UIN and the current monetary or unit value of branded media 118, which is updated during use thereof, may be stored directly on the prepaid CD gift card.

With regard to merchant server 126, merchant software 128 and merchant database 130 may, alternatively, include additional functionality. In one example, merchant server 126 provides an option to update periodically the “collectable,” by presenting an Internet link to consumer 132 to activate a more current collectable, such as a more current audio or video. Additionally, merchant software 128 may allow consumer 132 to download and store locally the actual audio or video file to his/her networked computer 134.

Additional functionality of merchant server 126 may also include generating user profiles (e.g., user transaction histories) and transmitting updated branded content or special promotions to MB transaction server 112 or to consumer 132 directly via his/her networked computer 134. For example, merchant server 126 transmits information, such as special offers, perhaps based on previous purchase behavior, as indicated in the user profiles, to consumer 132 directly via his/her networked computer 134. Thus, merchant software 128 of merchant server 126 may include a purchase behavior module for tracking purchase behavior by UIN and by building the user profiles. The module determines special offers that may be of interest to any given consumer 132, as tracked by the UIN of branded media 118.

Alternative Online Monetary Transaction Process Steps

In alternative process steps, at steps 218 through 222 of method 200 of FIG. 2, transaction software 114 of MB transaction server 112 does not perform an authentication operation as described. Instead, transaction software 114 serves to redirect the browser of consumer 132 to other web sites, such as the shopping web sites of merchants 124.

In other alternative process steps, at steps 218 through 222 of method 200 of FIG. 2, the request from branded media 118 that is executing on networked computer 134 to verify the UIN may be directed to a merchant server 124, rather than to transaction software 114 of MB transaction server 112. Instead, for example, during the checkout operation of step 230 of method 200, merchant software 128 of merchant server 126 prompts consumer 132 to enter the UIN and then sends the request to verify the UIN to transaction software 114 of MB transaction server 112. Alternatively, account information on consumer account database 116 of MB transaction server 112 is mirrored on merchant database 130 and, thus, merchant software 128 handles the UIN verification. Alternatively, a UIN verification process is performed during the checkout operation instead of at the initial activation of branded media 118, which allows consumer 132 to browse branded content of merchandise with further anonymity and without regard to the current account balance.

In other alternative process steps, if the UIN information resides on merchant database 130 of merchant server 126, rather than on consumer account database 116 of MB transaction server 112, at steps 220 and 222 of method 200 of FIG. 2, transaction software 114 of MB transaction server 112 queries merchant software 128 of merchant server 124 for the UIN information and then completes the authentication process.

In other alternative process steps, if the UIN information resides on any entity connected to network 140, such as bank 136, rather than on consumer account database 116 of MB transaction server 112, at steps 220 and 222 of method 200 of FIG. 2, transaction software 114 of MB transaction server 112 queries this entity for the UIN information and then completes the authentication process.

In other alternative process steps, in the case in which there is no UIN associated with each instance of branded media 118, or in the case in which the functionality of MB transaction server 112 is provided as a software application on branded media 118 that is executing on networked computer 134, the UIN authentication process of steps 218 through 222 of method 200 of FIG. 2 may be eliminated. In these examples, any consumer 132 who has physical possession of an instance of branded media 118 may conduct an online monetary transaction therewith, with no further authentication. Furthermore, in this example, the UIN and the current monetary or unit value of branded media 118, which is updated during use thereof, may be stored directly on the prepaid CD gift card.

In other alternative process steps, a process step occurs wherein MB transaction server 112 or merchant server 126 analyzes the online monetary transaction, in relation to the UIN of the particular instance of branded media 118, and generates a user profile and, thereby, tracks purchase behavior by UIN. User profiles may be exchanged between MB transaction server 112 and merchant server 126, for providing special offers to consumer 132 that are based on a history of his/her purchase behavior. Algorithms executing on transaction software 114 or merchant software 128 allow content of interest to be determined, based on UIN.

In other alternative process steps, in the case in which consumer 132 purchases downloadable branded digital content, the UIN authentication process of steps 218 through 222 of method 200 of FIG. 2 is eliminated. Instead, consumer 132 is prompted for the UIN for authentication at the time of downloading the branded digital content. If the UIN authentication fails, the download operation and online monetary transaction is canceled.

We claim:

1. A method for coordinating transactions comprising:
generating and associating a unique identification number with a payment token for distribution from an associated merchant;
receiving a unique identification number activation request;
creating a purchase account correlated to the unique identification number;
receiving a unique identification number registration request;
verifying that the registration unique identification number is the same as the activation unique identification number;
crediting the purchase account with a credit value associated with the unique identification number;
providing a link to online content including goods or services provided by the associated merchant;
receiving a purchase order selecting at least one presented good or service;
debiting the purchase account for an amount corresponding to the value of the at least one selected good or service;
facilitating transfer of the at least one selected good or service from the associated merchant;
effectuating payment of the associated merchant for the at least one selected good or service; and
enabling the purchase account to be supplemented with additional credit value.

2. The method of claim 1, further comprising:
distributing branded media with the payment token.

3. The method of claim 2, wherein the payment token is encoded with electronic data that includes the branded media.

4. The method of claim 3, wherein the activation request is generated from a merchant's point of sale apparatus.

5. The method of claim 3, wherein the credited value is determined based on the amount associated with an acquisition of the payment token.

6. The method of claim 3, wherein the credited valued is stored along with unique identification number information on a system database.

7. The method of claim 3, wherein the credited valued is stored along with unique identification number on the payment token.

8. A method for conducting transactions comprising:
receiving a payment token activation request;
receiving a payment token registration request;
creating an acquisition account with an account value based on account data associated with the payment token;
receiving an order that includes at least one selected purchase item;
debiting the acquisition account value an amount that corresponds to the at least one selected purchase item;
effectuating transfer of the at least one selected purchase item to a system user;
coordinating payment to a supplier of the at least one selected purchase item.

9. The method of claim 8, further comprising:
presenting an option to supplement the account value.

10. The method of claim 9, wherein the account value is determined based on data stored in the payment token.

11. The method of claim 9, wherein the account value is determined based on a data entry stored remotely.

12. The method of claim 11, wherein the account value is stored during a payment token distribution process.

13. The method of claim 11, wherein the account value is stored during a payment token activation process.

14. The method of claim 9, further comprising:
associating branded media with the payment token.

15. The method of claim 14, wherein the at least one selected item is selected from online content associated with the branded media.

16. The method of claim 14, wherein the at least one selected item is selected from online content associated the supplier of the at least one selected purchase item.

17. The method of claim 16, wherein the supplier is the generator of the payment token activation request.

18. The method of claim 14, wherein the branded media is stored on the payment token.

19. The method of claim 14, wherein the branded media is transferred to a networked computer after a payment token activation process.

20. The method of claim 19, wherein branded media updates are subsequently transferred to the networked computer.

21. The method of claim 14, further comprising:
generating a unique identification number; and
associating the unique identification number with the payment token.

22. The method of claim 21, further comprising:
verifying that a unique identification number received in the payment token activation request is that same as a unique identification number received in the payment token registration request.

23. A method for distributing branded media comprising:
transmitting a branded media distribution request to a merchant;
receiving a distribution request acceptance, wherein the acceptance defines parameters associated with formatting the branded media;
coordinating production and distribution of the branded media to the merchant.

24. The method of claim 23, further comprising:
receiving and filling a purchase order; and
coordinating payment of the merchant and a branded media production entity based on revenue generated by the purchase order.

25. The method of claim 24, wherein the branded media includes a payment token for effectuating anonymous purchases.

26. A system for coordinating transactions comprising:
a memory storing a program;
a processor in communication with said memory, said processor operative with said program to:
generate and associate a unique identification number with a payment token for distribution from an associated merchant;
receive a unique identification number activation request;
create a purchase account correlated to the unique identification number;
receive a unique identification number registration request;
verify that the registration unique identification number is the same as the activation unique identification number;
credit the purchase account with a credit value associated with the unique identification number;
provide a link to online content including goods or services provided by the associated merchant;
receive a purchase order selecting at least one presented good or service;
debit the purchase account for an amount corresponding to the value of the at least one selected good or service;
facilitate transfer of the at least one selected good or service from the associated merchant;
effectuate payment of the associated merchant for the at least one selected good or service; and
enable the purchase account to be supplemented with additional credit value.

27. The system of claim 26, further comprising instructions to issue signals to:
distribute branded media with the payment token.

28. The system of claim 27, wherein the payment token is encoded with electronic data that includes the branded media.

29. The system of claim 28, wherein the activation request is generated from a merchant's point of sale apparatus.

30. The system of claim 28, wherein the credited value is determined based on the amount associated with an acquisition of the payment token.

31. The system of claim 28, wherein the credited valued is stored along with unique identification number information on a system database.

32. The system of claim 28, wherein the credited valued is stored along with unique identification number on the payment token.

33. A system for conducting transactions comprising:
a memory storing a program;
a processor in communication with said memory, said processor operative with said program to:
receive a payment token activation request;
receive a payment token registration request;
create an acquisition account with an account value based on account data associated with the payment token;
receive an order that includes at least one selected purchase item;
debit the acquisition account value an amount that corresponds to the at least one selected purchase item;
effectuate transfer of the at least one selected purchase item to a system user;
coordinate payment to a supplier of the at least one selected purchase item.

34. The system of claim 33, further comprising instructions to issue signals to:
present an option to supplement the account value.

35. The system of claim 34, wherein the account value is determined based on data stored in the payment token.

36. The system of claim 34, wherein the account value is determined based on a data entry stored remotely.

37. The system of claim 36, wherein the account value is stored during a payment token distribution process.

38. The system of claim 36, wherein the account value is stored during a payment token activation process.

39. The system of claim 34, further comprising instructions to issue signals to:
associate branded media with the payment token.

40. The system of claim 39, wherein the at least one selected item is selected from online content associated with the branded media.

41. The system of claim 39, wherein the at least one selected item is selected from online content associated the supplier of the at least one selected purchase item.

42. The system of claim 41, wherein the supplier is the generator of the payment token activation request.

43. The system of claim 39, wherein the branded media is stored on the payment token.

44. The system of claim 39, wherein the branded media is transferred to a networked computer after a payment token activation process.

45. The system of claim 44, wherein branded media updates are subsequently transferred to the networked computer.

46. The system of claim 39, further comprising instructions to issue signals to:
generate a unique identification number; and
associate the unique identification number with the payment token.

47. The system of claim 46, further comprising instructions to issue signals to:
verify that a unique identification number received in the payment token activation request is that same as a unique identification number received in the payment token registration request.

48. A system for distributing branded media comprising:
a memory;
a processor disposed in communication with said memory, and configured to issue a plurality of processing instructions stored in the memory, wherein the instructions issue signals to:
transmit a branded media distribution request to a merchant;
receive a distribution request acceptance, wherein the acceptance defines parameters associated with formatting the branded media;
coordinate production and distribution of the branded media to the merchant.

49. The system of claim 48, further comprising:
instructions stored in the memory, wherein the instructions issue signals to:
receive and fill a purchase order; and
coordinate payment of the merchant and a branded media production entity based on revenue generated by the purchase order.

50. The system of claim 49, wherein the branded media includes a payment token for effectuating anonymous purchases.
